(19) United States
(12) Patent Application Publication
(10) Pub. No.: US 2023/0256458 A1
(43) Pub. Date: Aug. 17, 2023

(54) CENTRIFUGAL SEPARATOR

(71) Applicant: ebm-papst St. Georgen GmbH & Co. KG, St. Georgen (DE)

(72) Inventors: Gerhard KUHNERT, Villingen-Schwenningen (DE); Patrick STENGEL, St. Georgen (DE); Lars UEBERSOHN, Villingen-Schwenningen (DE)

(21) Appl. No.: 18/003,743

(22) PCT Filed: Jun. 30, 2021
(86) PCT No.: PCT/EP2021/067956

§ 371 Date: Dec. 29, 2022

(30) Foreign Application Priority Data
Jul. 2, 2020 (DE) 10 2020 117 515.9

(51) Int. Cl. B04B 5/08; B04B 9/04; B04B 9/12; B04B 11/02; B01D 45/14; B04B 15/02; F01M 13/04

(52) U.S. Cl. CPC B04B 5/08; B04B 9/04; B04B 9/12; B04B 11/02; B01D 45/14; B04B 15/02; F01M 13/04; F01M 2013/0422

(57) ABSTRACT

A centrifugal separator for separating oil, the centrifugal separator comprising a centrifuge housing, a drive housing, a separating rotor, a shaft, a first bearing, a second bearing and a drive. A drive chamber is formed in the drive housing and a separating chamber is formed in the centrifuge housing. A partition wall is formed between the drive chamber and the separating chamber, and the partition wall comprises an opening. The shaft extends through the opening of the partition wall into the separating chamber and into the drive chamber, and the separating rotor is connected to the shaft for conjoint rotation and is arranged in the separating chamber. The drive is arranged in the drive chamber and drives the shaft, and the drive is in the form of an electric motor which drives the shaft directly in such a way that the shaft forms a motor shaft of the electric motor.

### CROSS-REFERENCES TO RELATED APPLICATIONS

This Application is a Section 371 National Stage Application of International Application No. PCT/EP2021/067956, filed Jun. 30, 2021, and published as WO 2022/003003 A1 on Jan. 6, 2022, and claims priority to German Application No. 10 2020 117 515.9, filed Jul. 2, 2020, the contents of both are hereby incorporated by reference in their entirety.

### BRIEF DESCRIPTION OF THE DRAWINGS

FIG. 1a is a schematic sectional view of an upper part of a first embodiment variant of a centrifugal separator.

FIG. 1b is a schematic sectional view of a lower part of a first embodiment variant of the centrifugal separator, the upper part of which has already been shown in FIG. 1a.

FIG. 2 is a schematic sectional view of a second embodiment variant of a centrifugal separator.

### DETAILED DESCRIPTION

The present disclosure generally relates to a centrifugal separator, for example according to the preamble of claim 1.

Centrifugal separators, in particular for separating oil from a blow-by gas of an internal combustion engine, are known in principle. A blow-by gas is in principle understood as being a gas which escapes into the crankcase through leaks between the piston, the piston rings and the cylinder surfaces and on its path to a crankcase ventilation system takes up oil. In order to clean this blow-by gas before it is discharged into the environment and to feed the oil that has been taken up back into the crankcase, centrifugal separators are used.

DE 20 2016 106 867 U1 discloses an oil separator in the form of a centrifugal separator, which comprises a centrifuge housing, a drive housing, a separating rotor, a shaft, a first bearing, a second bearing and a drive, wherein a drive chamber is formed in the drive housing, wherein a separating chamber is formed in the centrifuge housing, wherein a partition wall is formed between the drive chamber and the separating chamber, wherein the shaft extends through the partition wall into the separating chamber and into the drive chamber, wherein the separating rotor is connected to the shaft for conjoint rotation and is arranged in the separating chamber, wherein the drive is arranged in the drive chamber and drives the shaft.

An object of the present disclosure is to propose a centrifugal separator which is of simple construction, compact and robust.

This object is achieved, proceeding from the features of the preamble of claim 1, by the characterizing features of claim 1. Advantageous and expedient further developments are indicated in the dependent claims.

The centrifugal separator according to the present disclosure for separating oil comprises a centrifuge housing, a drive housing, a separating rotor, a shaft, a first bearing, a second bearing and a drive, wherein a drive chamber is formed in the drive housing, wherein a separating chamber is formed in the centrifuge housing, wherein a partition wall is formed between the drive chamber and the separating chamber, wherein the partition wall comprises an opening, wherein the shaft extends through the opening of the partition wall into the separating chamber and into the drive chamber, wherein the separating rotor is connected to the shaft for conjoint rotation and is arranged in the separating chamber, wherein the drive is arranged in the drive chamber and drives the shaft, and wherein the drive is in the form of an electric motor which drives the shaft directly such that the shaft forms a motor shaft of the electric motor. A simple, compact and robust construction of the centrifugal separator is thereby provided.

According to a first embodiment variant, it is provided that the first bearing is mounted in the opening of the partition wall and the shaft passes through the first bearing. The shaft is thereby mounted in a central region of a general housing formed of the centrifuge housing and the drive housing. By means of this arrangement, a compact and robust construction of the centrifugal separator is provided.

It is further provided that the electric motor comprises a split case, wherein a hollow cylindrical middle portion of the split case is arranged between a rotor of the electric motor and a stator of the electric motor. A stator surrounding the rotor is thereby accommodated in a protected manner between the drive housing and the split case, so that this electrical component of the electric motor is encapsulated with respect to separated oil.

It is also provided that the split case comprises above the middle portion an annular flange facing the partition wall and is thereby sealed with respect to the partition wall, in particular with the interposition of a circumferential seal. A technically simple and optimally acting connection of the split case to the partition wall is thereby achieved.

It is also provided that the split case forms a connecting piece beneath the middle portion and is thereby held in an opening of the drive housing, in particular with the interposition of a circumferential seal, wherein it is in particular also provided that the connecting piece is configured in such a way that an oil duct can be connected from outside. A technically simple and optimally acting connection of the split case to the drive housing is thereby also achieved opposite the partition wall. Because the opening of the partition wall and the opening of the drive housing are opposite one another, it is possible to clamp the split case between the partition wall and a base of the drive housing opposite the partition wall and thus permanently maintain contact pressure on the seals.

A second embodiment variant of the present disclosure provides that the shaft extends through an opening of the drive housing, or through the opening mentioned in claim 5 of the drive housing, and the first bearing is arranged outside the drive chamber and is mounted on the drive housing. Particularly stable mounting of the shaft is thereby provided, which also allows the bearing to be overhauled with minimum outlay, because the drive housing does not have to be dismantled for the overhaul.

It is also provided that the partition wall is formed by a base of the centrifuge housing. By using the base of the centrifuge housing as a cover for the drive housing in this way, material can be saved. In the first embodiment variant, this construction allows the electric motor to be replaced rapidly, because it can be removed from the centrifuge housing together with the drive housing in an uncomplicated manner

It is further provided that an air gap is formed, in particular circumferentially, between the split case and the rotor, wherein the air gap is in particular of such a size that the split case is spaced apart from the rotor in such a way that oil is able to flow unhindered in the direction of a longitudinal axis of the shaft at an inside wall of the split case. Such a form ensures that the functioning of the electric motor is not impaired by outflowing oil, and that outflowing oil does not build up in the region of the rotor and brake the electric motor.

In respect of both embodiment variants, it is provided that the first bearing is formed without a seal, in such a manner that oil is able to flow between the inner ring and an outer ring of the first bearing along rolling elements of the bearing. It is thereby ensured in the first embodiment variant that the outflowing oil is able to flow from the separating chamber into the drive chamber without the formation of an undesirable build-up. It is thereby ensured in the second embodiment variant that the outflowing oil is able to flow from the drive chamber through the opening of the drive housing and into an oil duct without the formation of an undesirable build-up. In both embodiment variants, continuous lubrication of the first bearing is thereby ensured, so that wear thereof is minimized and a predicted service life can reliably be achieved.

It is also provided that the first bearing is in the form of a drain and that an upper side of the partition wall is shaped in such a way that oil that collects on the upper side flows to the first bearing when the shaft is standing vertically in space. The undesirable formation of a build-up of outflowing oil is thereby avoided.

It is further provided that the centrifugal separator comprises an impeller, wherein the impeller is driven by the shaft and in particular is connected to the shaft for conjoint rotation, wherein the impeller is arranged in particular in the split case adjacent to a rotor of the electric motor and in particular beneath or above the rotor of the electric motor. By equipping the centrifugal separator with such an impeller, an outflow of the separated oil through the electric motor can be further improved, so that the likelihood of the formation of an undesirable build-up is further reduced and thus extremely reliable operation of the centrifugal separator in respect of the discharge of separated oil is achieved.

It is further provided that a low pressure is generated in the split case by the rotating impeller between the opening of the partition wall and the impeller, and that an overpressure is generated towards the opening of the drive housing by the rotating impeller in dependence on the arrangement thereof beneath or above the rotor. Such a design of the impeller additionally furthers an outflow of separated oil without build-up.

It is also provided that a stator of the electric motor either lies directly against an inner peripheral surface of the drive housing or lies indirectly against an inner peripheral surface of the drive housing with the interposition of a thermal conductor. Optimal cooling of the electric motor by way of the drive housing and in addition by way of the centrifuge housing connected to the drive housing is thereby ensured.

It is further provided that electronic components of an electronic unit of the electric motor are connected in a heat-conducting manner to an inner side of a base of the drive housing by way of an electrically insulating heat-conducting medium, in particular a heat-conducting paste, wherein the electronic components are in particular arranged on a circuit board. Optimal cooling of the electronic components of the electric motor is thereby ensured, so that overheating of those components is reliably avoided.

It is also provided that the drive housing comprises a connecting flange facing the centrifuge housing and is thereby connected to a counter-flange formed on an underside of a base of the centrifugal housing, in such a manner that the drive chamber is closed on all sides. Such a construction ensures that the centrifuge housing and the drive housing are reliably and stably held together, and that the drive housing, or the electric motor accommodated in the drive housing, is easily oriented on the centrifuge housing. It is further ensured that the drive housing can be dismantled and assembled easily and in a time-saving manner for overhaul purposes.

It is further provided that the centrifugal separator is in the form of a blow-by gas centrifugal separator for an internal combustion engine.

It is also provided that an inlet through which the blow-by gas flows into the separating chamber is formed by the second bearing or by the second bearing and at least one feed channel (143a, 143b) passing through the centrifuge housing. By means of such a configuration, the centrifuge housing can be produced with more advantageous tool costs, because fewer openings have to be provided. Furthermore, the second bearing can thereby be lubricated permanently, inexpensively and effectively, whereby the service life thereof is increased.

Finally, it is provided that the centrifugal separator comprises a blow-by gas connection, wherein the blow-by gas connection is of such a size and is arranged on the centrifuge housing in such a way that the second bearing is thereby supplied with blow-by gas or that the second bearing and the at least one feed channel are thereby supplied with blow-by gas. By means of such a blow-by gas connection, the centrifugal separator can easily be connected to an internal combustion engine.

Within the meaning of the present disclosure, the separation of oil also includes the separation of dirt particles which are contained in the blow-by gas.

Further details of the present disclosure are described in the drawing by means of exemplary embodiments which are shown schematically.

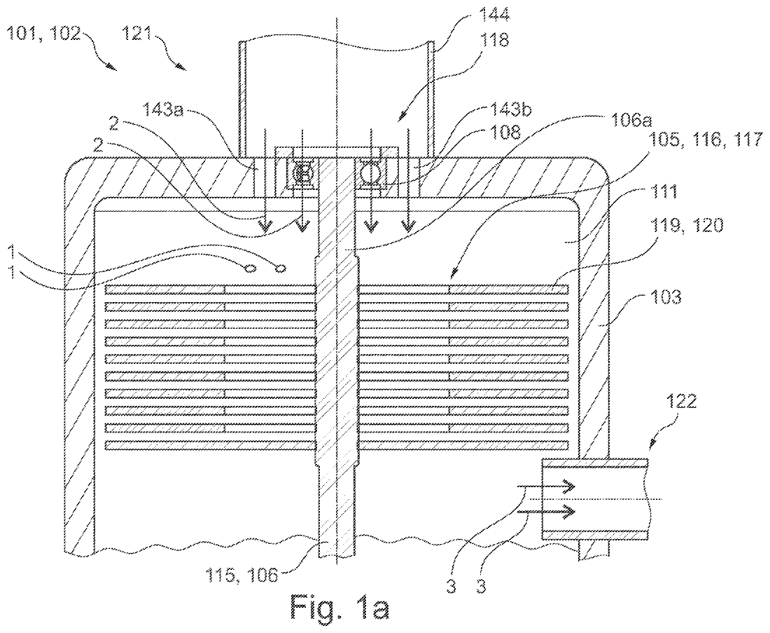

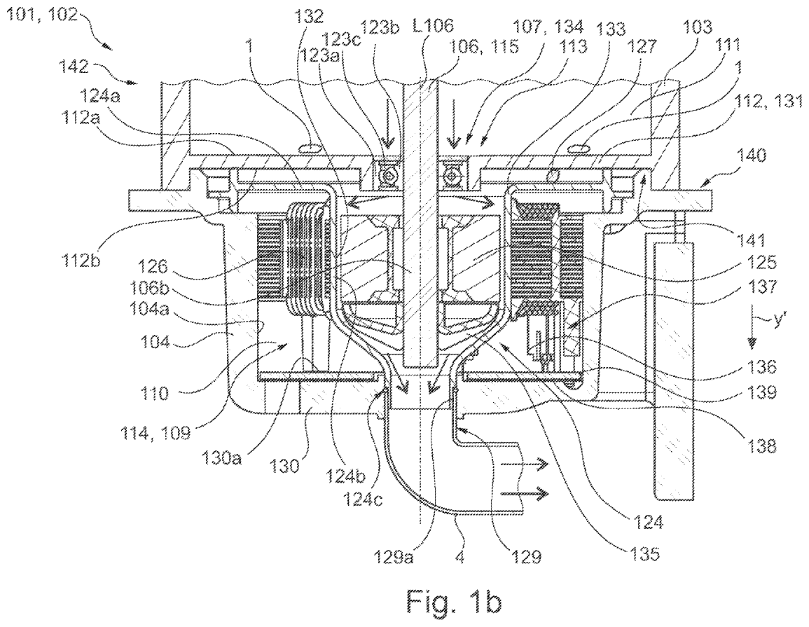

FIGS. 1a and 1b show, in schematic views and split between two figures, a first embodiment variant of a centrifugal separator 101 according to the present disclosure, wherein the centrifugal separator 101 is in the form of a blow-by gas centrifugal separator 102. FIG. 1a shows an upper part of the centrifugal separator 101 and FIG. 1b shows a lower part of the centrifugal separator 101.

The centrifugal separator 101 for separating oil 1 comprises a centrifuge housing 103, a drive housing 104, a separating rotor 105, a shaft 106, a first bearing 107, a second bearing 108 and a drive 109. A drive chamber 110 is thereby formed in the drive housing 104 and a separating chamber 111 is thereby formed in the centrifuge housing 103. A partition wall 112 is formed between the drive chamber 110 and the separating chamber 111, wherein the partition wall 112 comprises an opening 113. The shaft 106 extends through the opening 113 of the partition wall 112 into the separating chamber 111 and into the drive chamber 110. The separating rotor 105 is connected to the shaft 106 for conjoint rotation and is arranged in the separating chamber 111. The drive 109 is arranged in the drive chamber 110 and drives the shaft 106. The drive 109 is in the form of an electric motor 114 which drives the shaft 106 directly in such a way that the shaft 106 forms a motor shaft 115 of the electric motor 114.

Although the centrifuge housing 103 and the shaft 106 are shown with different hatching in FIGS. 1a and 1b and the wall thicknesses of the centrifuge housing 103 that are shown in FIGS 1a and 1b differ from one another, the general construction of the centrifugal separator 101 is to be understood such that an upper portion of the centrifuge housing 103 shown in FIG. 1a is fitted to the lower portion, visible in FIG. 1b, of the centrifuge housing 103, and the closed separating chamber 111 is thereby formed.

The separating rotor 105 is shown by way of example as a plate pack 116 in the form of a disc stack 117. Above the separating rotor 105 the centrifuge housing 103 has a further opening 118 in which the second bearing 108 is accommodated. In principle, plate packs 116 with a wide variety of geometric shapes of the plates can be used. The discs 119 shown in FIG. 1a form flat plates 120. This structural form serves only as an example to explain the construction of the separating rotor 105. It is provided to configure the separating rotor 105 in accordance with the particular requirements.

The centrifugal separator 101 further comprises at the centrifuge housing 103 an inlet 121 and an outlet 122, both of which are shown purely schematically. So-called blow-by gas 2 flows into the separating chamber 111 by way of the inlet 121, and cleaned gas 3 flows out of the separating chamber by way of the outlet 122.

The first bearing 107, which is also referred to as the lower bearing, is mounted in the opening 113 of the partition wall 112. The partition wall 112 is thereby formed by the centrifuge housing 103. The shaft 106 passes through the first bearing 107. In relation to the first bearing 107 and an orientation of the centrifugal separator 101 in space, the separating rotor 105 is mounted at an upper end 106a of the shaft 106 and the electric motor 114 is arranged at a lower end 106b of the shaft 106.

The oil 1 separated from the blow-by gas 2 collects on an upper side 112a of the partition wall 112 and flows through the first or lower bearing 107, which is in the form of a rolling bearing, between its outer ring 123a and its inner ring 123b past its rolling elements 123c and into the drive chamber 110. According to an alternative embodiment variant, the upper and the lower bearings are not in the form of rolling bearings but in the form of sliding bearings. It can also be provided for one of the two bearings to be in the form of a rolling bearing and the other of the two bearings to be in the form of a sliding bearing.

The electric motor 114 comprises a split case 124, wherein a hollow cylindrical middle portion 124b of the split case 124 is arranged between a rotor 125 of the electric motor 114 and a stator 126 of the electric motor 114. Above the middle portion 124b, the split casing 124 comprises an annular flange 124a facing the partition wall 112. According to an embodiment variant incorporated by way of example in FIG. 1b, the split case 124, by means of the annular flange 124a, lies in a sealing manner against an underside 112b of the partition wall 112 with the interposition of a circumferential seal 127. Alternatively, sealing radial contact can also be provided either with or without a seal. In principle, the split case and any sealing components present are in such a form that the outflowing oil is located in the drive chamber solely inside the split case and a part of the drive chamber located outside the split case is reliably protected against the ingress of outflowing oil.

Beneath the middle portion 124b, the split case 124 comprises a connecting piece 124c. The split case 124 is thereby held in an opening 129 of the drive housing 104 with the interposition of a circumferential seal 128. The seal 128 thereby lies against a wall 129a of the opening 129. The opening 129 is formed in a base 130 of the drive housing 104. The connecting piece 124c, in a region in which it passes through the opening 129 and extends beyond the seal 128, is thereby formed in such a manner that a tubular oil duct 4 can be connected to the connecting piece 124c.

The opening 129 formed in the base 130 of the drive housing 104 is located directly opposite, based on a longitudinal axis L106 of the shaft 106, the opening 113 formed in the partition wall 112.

The partition wall 112 is formed by a base 131 of the centrifuge housing 103. The drive housing 104 is configured so as to be open towards the partition wall 112.

A circumferential air gap 132 is formed between the split case 124 and the rotor 125, wherein the air gap 132 is of such a size that the centrifugal separator 101 is spaced apart from the rotor 125 in such a way that oil is able to flow unhindered in the y′ direction of the longitudinal axis L106 of the shaft 106 at an inside wall 133 of the split case 124.

The first or lower bearing 107 already mentioned above is formed without a seal, so that separated oil is able to flow between the inner ring 123b and the outer ring 123a both when the shaft 106 is stationary and when the shaft 106 is rotating.

The first or lower bearing 107 is thus in the form of a drain 134. According to one embodiment variant, it can thereby also be provided that the upper side 112a of the partition wall 112 is funnel-shaped, so that oil 1 that collects on the upper side 112a is guided to the drain 134 when the shaft 106 is standing vertically in space.

The centrifugal separator 101, or the electric motor 114, comprises an impeller 135. The impeller 135 is driven by the shaft 106 and for that purpose is connected to the shaft 106 for conjoint rotation. The impeller 135 is arranged in the split case 124 adjacent to the rotor 125 of the electric motor 114 and beneath the rotor 125. The electric motor 114 is thus of compact construction. Alternatively, the impeller can also be arranged above the rotor. A compact construction of the motor is thereby also achieved. According to a further variant, it can be provided that the impeller is in two-part form, such that one impeller portion is formed above the rotor and one impeller portion is formed beneath the rotor.

By means of the rotating impeller 135, a low pressure is generated in the split case 124 between the opening 113 of the partition wall 112 and the impeller 135. Furthermore, an overpressure is generated by means of the rotating impeller 135 beneath the rotor 125 towards the opening 129 in the base 130 of the drive housing 104. Discharge of the separated oil in the direction of the arrow y′ is thereby assisted.

The stator 126 of the electric motor 114 lies directly against an inner peripheral surface 104a of the drive housing 104. Electronic components 136 of an electronic unit 137 of the electric motor 114 are connected in a heat-conducting manner to an inner side 130a of the base 130 of the drive housing 104 by way of an electrically insulating heat-conducting medium 138. The electronic components 136 are thereby arranged on a circuit board 139.

The drive housing 104 comprises a connecting flange 140 facing the centrifuge housing 103 and is connected thereto by a counter-flange 141 formed on the underside 112b of the partition wall 112 of the centrifuge housing 103, in such a way that a stable general housing 142 is formed and the drive chamber 110 is closed on all sides.

The inlet 121, through which the blow-by gas 2 flows into the separating chamber 111 (see FIG. 1a), is formed by the second bearing 108 and two feed channels 143a, 143b passing through the centrifuge housing 103. It can further be seen from FIG. 1a that the centrifugal separator 101 comprises a blow-by gas connection 144. The blow-by gas connection is of such a size and is arranged on the centrifuge housing 103 in such a way that blow-by gas 2 is thereby admitted both to the second bearing 108 and to the feed channels 143a, 143b. The blow-by gas 2 can thus flow into the separating chamber through the upper bearing 108 and through the feed channels 143a, 143b.

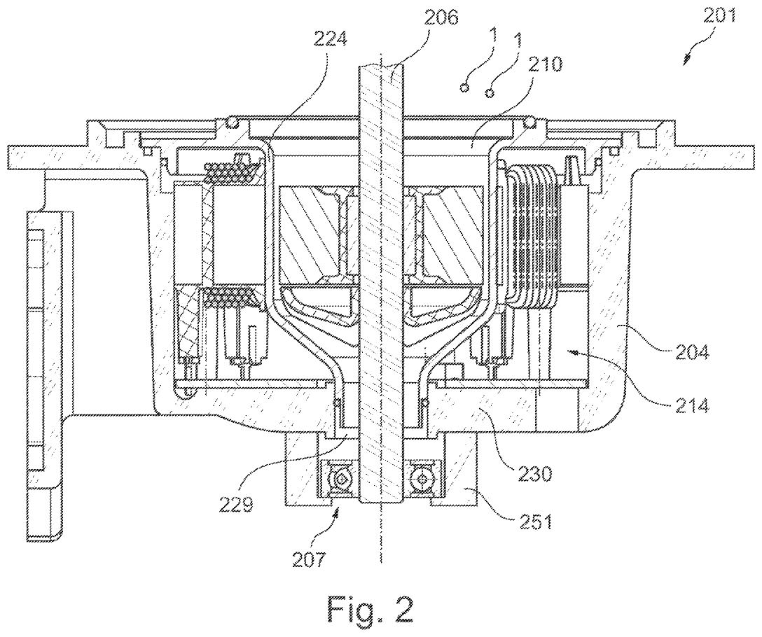

FIG. 2 shows, in a schematic sectional view, a second embodiment variant of a centrifugal separator 201 according to the present disclosure. A centrifuge housing of the centrifugal separator 201 is thereby not shown. It is, however, in principle of a comparable form to the centrifuge housing shown in FIGS. 1a and 1b. In this respect, reference is made to the description thereof.

Unlike the centrifuge housing of the first embodiment variant, although the centrifuge housing of the second embodiment variant has the opening arranged in the partition wall, it does not have a first bearing mounted in the opening. Instead, the first bearing 207 of the second embodiment variant is arranged beneath an electric motor 214, as is shown in FIG. 2.

Oil 1 is thus able to flow through the opening (not shown) of the partition wall directly into a drive chamber 210 of a drive housing 204.

A shaft 206 extends through an opening 229 of the drive housing 204, wherein the first bearing 207—as mentioned—is arranged outside the drive chamber 210 and is mounted on the drive housing 204.

In addition, an electric motor 214 with its split case 224 and the drive housing 204 are of a comparable form to the first embodiment variant shown in FIGS. 1a and 1b. In this respect, reference is made to the description thereof.

The first or lower bearing 207 of the second embodiment variant shown in FIG. 2 is also passed through and lubricated by the separated oil. However, in the second embodiment variant, the separated oil first flows through the electric motor 214 along the split case 224 and only passes through the first bearing 207 after it has flowed through the opening 229 in a base 230 of the drive housing 204. For accommodating and mounting the first bearing 207, the drive housing 204 is supplemented compared to the drive housing of the first variant with a hollow cylindrical bearing mount 251, which is connected to the base 230 of the drive housing 204. According to an embodiment variant which is not shown, the bearing mount 251 is configured in such a way that it comprises a connecting piece for connection of an oil duct. A second bearing (not shown) is arranged according to Figure la and is lubricated by means of a blow-by gas supplied to the centrifugal separator 201 from an associated internal combustion engine.

In principle, it is additionally also mentioned that the first bearing without a seal entails the advantage that it is possible to achieve service lives for the centrifugal separator that far exceed the service life of shaft seals. This is important in order to be able to meet the high requirements that are made of the operational performance of centrifugal separators.

When the shaft is driven by the rotor of the electric motor, oil separation takes place in the centrifuge housing, through which the blow-by gas flows, of the centrifugal separator. All the separated oil then passes through the first or lower bearing, which is also referred to as the lower shaft bearing. By means of an impeller located on the same shaft, on the one hand a low pressure is generated, which both assists the oil flow through the air gap between the rotor and the split case, and on the other hand an overpressure is also built up, which ensures the flow of oil in the direction towards the crankcase of the internal combustion engine. The oil duct to the crankcase can both be mounted externally on the drive housing, which at the same time forms a further part of the centrifuge housing, and be integrated directly in the drive housing. The stator and the circuit board having the electronics for the motor control are so arranged in the drive housing that the lost heat from the stator directly and the lost heat from the electronic components on the circuit board can be dissipated to the cooler drive housing by way of a heat-conducting medium in the form of heat-conducting paste.

In the second embodiment variant, the first bearing, which is also referred to as the lower shaft bearing, is located beneath the rotor. In the case of this arrangement too, all the separated oil passes through the first bearing and serves to lubricate the first bearing and to dissipate the lost heat.

Constructions according to the first and second embodiment variants achieve in particular the advantages mentioned below:
reliable functioning of the electric motor over the required service life;
avoidance of deposits in the split case;
cost saving by dispensing with a shaft seal;
no loss of performance owing to the shaft seal, lower heat load in the region of the first bearing;
cooling and lubrication of the first bearing or shaft bearing by the separated oil;
reliable guiding of the separated oil back into the crankcase of the internal combustion engine;
reliable operation, even when the drive shaft is pivoted by up to ±45° or the centrifugal separator as a whole is pivoted from the vertical position;
cooling of the stator of the electric motor and of the electronic components on the circuit board by way of the centrifuge housing or drive housing.

Although the present invention has been described with reference to preferred embodiments, workers skilled in the art will recognize that changes may be made in form and detail without departing from the spirit and scope of the invention.

List of reference numerals:
1 oil
2 blow-by gas
3 cleaned gas
4 oil duct
101 centrifugal separator
102 blow-by gas centrifugal separator
103 centrifuge housing
104 drive housing
104a inner peripheral surface of 104
105 separating rotor
106 shaft
106a upper end of 106
106b lower end of 106
107 first bearing/lower bearing
108 second bearing
109 drive
110 drive chamber
111 separating chamber
112 partition wall
112a upper side of the partition wall 112
112b underside of the partition wall 112
113 opening in 112
114 electric motor
115 motor shaft
116 plate pack
117 disc stack
118 further opening in 103
119 disc
120 flat plate
121 inlet
122 outlet
123a outer ring of 107
123b inner ring of 107
123c rolling elements of 107
124 split case
124a annular flange
124b middle portion of 124
124c connecting piece
125 rotor of 114
126 stator of 114
127 seal of 124a of 124
128 seal of 124c of 124
129 opening of the drive housing
129a wall of 129
130 base of 104
130a inner side of 130
131 base of 103
132 air gap between 124 and 125
133 inside wall of 124
134 drain
135 impeller
136 electronic components
137 electronic unit
138 heat-conducting medium
139 circuit board
140 connecting flange of 104
141 counter-flange on 112
142 general housing
143a, 143b feed channel
144 blow-by gas connection
L106 longitudinal axis of the shaft
201 centrifugal separator
204 drive housing
206 shaft
207 first bearing
210 drive chamber
214 electric motor
224 split case
229 opening of 204
251 hollow cylindrical bearing mount

1. A centrifugal separator for separating oil, the centrifugal separator comprising a centrifuge housing, a drive housing, a separating rotor, a shaft, a first bearing, a second bearing and a drive,
wherein a drive chamber is formed in the drive housing,
wherein a separating chamber is formed in the centrifuge housing,
wherein a partition wall is formed between the drive chamber and the separating chamber,
wherein the partition wall comprises an opening,
wherein the shaft extends through the opening of the partition wall into the separating chamber and into the drive chamber,
wherein the separating rotor is connected to the shaft for conjoint rotation and is arranged in the separating chamber,
wherein the drive is arranged in the drive chamber and drives the shaft,
wherein the drive is in the form of an electric motor which drives the shaft directly in such a way that the shaft forms a motor shaft of the electric motor, and
wherein the electric motor comprises a split case, wherein a hollow cylindrical middle portion of the split case is arranged between a rotor of the electric motor and a stator of the electric motor.

2. The centrifugal separator as claimed in claim 1, wherein the first bearing is mounted in the opening of the partition wall and the shaft passes through the first bearing.

3. (canceled)

4. The centrifugal separator as claimed in claim 1, wherein the split case comprises above the middle portion an annular flange facing the partition wall and is thereby sealed with respect to the partition wall with the interposition of a circumferential seal.

5. The centrifugal separator as claimed in claim 1, wherein the split case forms a connecting piece beneath the middle portion and is thereby held in an opening of the drive housing with the interposition of a circumferential seal.

6. The centrifugal separator as claimed in claim 5, wherein the shaft extends through the opening of the drive housing, and the first bearing is arranged outside the drive chamber and is mounted on the drive housing.

7. The centrifugal separator as claimed in claim 1, wherein the partition wall is harmed by a base of the centrifuge housing.

8. The centrifugal separator as claimed in claim 1, wherein an air gap is formed, circumferentially, between the split case and the rotor, wherein the air gap is in particular of such a size that the split case is spaced apart from the rotor in such a way that oil is able to flow unhindered in the direction of a longitudinal axis of the shaft at an inside wall of the split case.

9. The centrifugal separator as claimed in claim 2, wherein the first bearing is formed without a seal, in such a manner that oil is able to flow between the inner ring and an outer ring of the first bearing along rolling elements of the bearing.

10. The centrifugal separator as claimed in claim 1, wherein the first bearing is in the form of a drain, and in that an upper side of the partition wall is shaped in such a way that oil that collects on the upper side flows to the first bearing when the shaft is standing vertically in space.

11. The centrifugal separator as claimed in claim 1, wherein the centrifugal separator comprises an impeller, wherein the impeller is driven by the shaft and is connected to the shaft for conjoint rotation, wherein the impeller is arranged in the split case adjacent to a rotor or the rotor of the electric motor and beneath or above the rotor of the electric motor.

12. The centrifugal separator as claimed in claim 11, wherein a low pressure is generated in the split case by the rotating impeller between the opening of the partition wall and the impeller, and an overpressure is generated towards the opening of the drive housing by the rotating impeller in dependence on the arrangement thereof beneath or above the rotor.

13. The centrifugal separator as claimed in claim 1, wherein a stator of the electric motor either lies directly against an inner peripheral surface of the drive housing or lies indirectly against an inner peripheral surface of the drive housing with the interposition of a thermal conductor.

14. The centrifugal separator as claimed in claim 1, wherein electronic components of an electronic unit of the electric motor are connected in a heat-conducting manner to an inner side of a base of the drive housing by way of an electrically insulating heat-conducting medium, in particular a heat ctnducting paste, wherein the electronic components are arranged on a circuit board.

15. The centrifugal separator as claimed in at claim 1, wherein the drive housing comprises a connecting flange facing the centrifuge housing and is thereby connected to a counter-flange formed on the underside of the partition wall of the centrifuge housing, in such a manner that the drive chamber is closed on all sides.

16. The centrifugal separator as claimed in claim 1, wherein the centrifugal separator is in the form of a blow-by gas centrifugal separator for an internal combustion engine.

17. The centrifugal separator as claimed in claim 1, wherein an inlet through which the blow-by gas flows into the separating chamber is formed by the second bearing or by the second bearing and at least one feed channel passing through the centrifuge housing

18. The centrifugal separator as claimed in claim 17, wherein the centrifugal separator comprises a blow-by gas connection wherein the blow-by gas connection is of such a size and is arranged on the centrifuge housing in such a way that the second bearing is thereby supplied with blow-by gas or that the second bearing and the at least one feed channel are thereby supplied with blow-by gas.

19. The centrifugal separator as claimed in claim 14, wherein the electrically insulating heat-conducting medium comprises a heat-conducting paste.

20. The centrifugal separator as claimed in claim 1, wherein the shaft extends through an opening of the drive housing, and the first bearing is arranged outside the drive chamber and is mounted on the drive housing.
